(19) United States
(12) Patent Application Publication
(10) Pub. No.: US 2007/0107957 A1
(43) Pub. Date: May 17, 2007

(54) Automobile propulsion system

(76) Inventor: Lonnie Lehrer, Bedford, NY (US)

Correspondence Address: BINGHAM MCCUTCHEN LLP, 2020 K Street, N.W., Intellectual Property Department, WASHINGTON, DC, 20006, US

(21) Appl. No.: 11/599,280

(22) Filed: Nov. 15, 2006

Related U.S. Application Data
(60) Provisional application No. 60/736,872, filed on Nov. 16, 2005.

(51) Int. Cl. B60K 6/04

(52) U.S. Cl. 180/65.2

(57) ABSTRACT

An automobile propulsion system is disclosed. The system utilizes, at least in part, an electric motor to propel a vehicle. This is achieved by using the drive shaft of the vehicle as the axle of the motor. The electric motor can be used in conjunction with an internal combustion engine. The electric motor may be used to take over the continuous spinning of the vehicle drive train once the vehicle has reached a certain speed, or from a complete stop. This saves fuel, reducing the costs associated with operating the vehicle and decreasing the amount of toxic emissions and pollution. The vehicle motion can also be used to generate electrical power, which can be stored either in a capacitor, battery, or other device and which can be used later by the electric motor. The electric motor may be used with newly manufactured vehicles, or it may be retrofitted to previously manufactured vehicles.

### CROSS-REFERENCE TO RELATED APPLICATIONS

This application claims the benefit of U.S. Provisional Patent Application No. 60/736,872 filed on Nov. 16, 2005, which is incorporated herein by reference in its entirety.

### BACKGROUND OF THE INVENTION

1. Field of the Invention

The present invention relates to an automobile propulsion system, and, more particularly, the present invention relates to an automobile powered at least in part by an electric motor in which the rotor of the motor also functions as the vehicle drive shaft.

2. Description of the Related Art

Electrically powered automobiles are known. These automobiles typically include an electric motor, powered by an array of rechargeable batteries. The motor may be either a direct current (DC) motor or an alternating current (AC) motor. A controller is also included for transferring power from the batteries to the motor and determining when to utilize the engine to propel the vehicle and when to utilize the electric motor to propel the vehicle. The batteries may be recharged through an external power source, through an inductive charging device located within the vehicle, or a combination of the two. If an AC motor is used, the batteries may also be recharged through vehicle braking.

Electric-gasoline hybrid engines are also known. These engines include both an electric motor and an internal combustion engine. The internal combustion engine of a hybrid vehicle is typically smaller than that used for a strictly gasoline-powered vehicle. The electric motor assists the internal combustion engine in providing power when needed, such as when accelerating or going up-hill.

### SUMMARY OF THE INVENTION

The present invention utilizes, at least in part, an electric motor to propel a vehicle. This is achieved by using the drive shaft of the vehicle as the axle of the motor. The electric motor can be used in conjunction with an internal combustion engine. The electric motor may be used to take over the continuous spinning of the vehicle drive train once the vehicle has reached a certain speed, or from a complete stop. This saves fuel, reducing the costs associated with operating the vehicle and decreasing the amount of toxic emissions and pollution. The fuel savings will occur because the vehicle can maintain velocity at a much lower engine output. It is also possible to actually have the engine shut down while operating under the electric motor, further increasing fuel savings and environmental benefit. The vehicle motion can also be used to generate electrical power, which can be stored either in a capacitor, battery, or other device and which can be used later by the electric motor. The electric motor may be used with newly manufactured vehicles, or it may be retrofitted to previously manufactured vehicles.

### DESCRIPTION OF THE DRAWINGS

The present invention is described with reference to the accompanying drawings, wherein:

FIG. 1 shows a front view of a hybrid automobile propulsion system of the present invention;

FIG. 2 shows a top view of a first magnet placement scheme for the propulsion system of FIG. 1;

FIG. 3 shows a top view of a second magnet placement scheme for the propulsion system of FIG. 1;

FIG. 4 shows a top view of a housing for use with the propulsion system of FIG. 1;

FIG. 5 shows a graph of engine speed versus engine torque for a motor assist setup of the present invention;

FIG. 6 shows a schematic diagram for an automobile engine and drive train of the present invention; and

FIG. 7 shows a graphic representation of an automobile engine and drive train of the present invention.

### DETAILED DESCRIPTION OF THE INVENTION

The present invention relates to an automobile powered at least in part by an electric motor. In one embodiment, magnetic repulsion is used to propel the vehicle. A first set of magnets are arrayed in a spiral effect along the length of the drive shaft. A second set of magnets is positioned either on the underbody of the vehicle or on a housing that will be placed as a cover to the drive shaft. Sensors are positioned at each magnet on the drive shaft and housing or underbody. The electricity to power both sets of magnets is supplied by the alternator and battery. Optional additional sources of energy may include additional batteries or condensers, which emit short bursts of a more powerful charge.

The sensors, when aligned, will initiate the charging of the magnets and the resulting repulsion. As an example, if there are six sets of magnets along the length of the drive shaft, set number one will fire when the sensors are aligned properly. Thereafter, and in order to keep the drive shaft spinning, magnet set two will fire when aligned as detected by the sensors. Magnet sets three through six will follow in order. As the shaft completes its rotation, the entire process will begin again with set number one. The firing of the magnets via the sensors will be controlled by a computer chip.

As a safety feature, any time the driver touches either the brake or the gas pedal, the magnetic drive will disengage in the same fashion that a vehicle disengages from cruise control when the brake pedal is touched. The magnetic drive can also be disengaged manually through a control utilized by the driver.

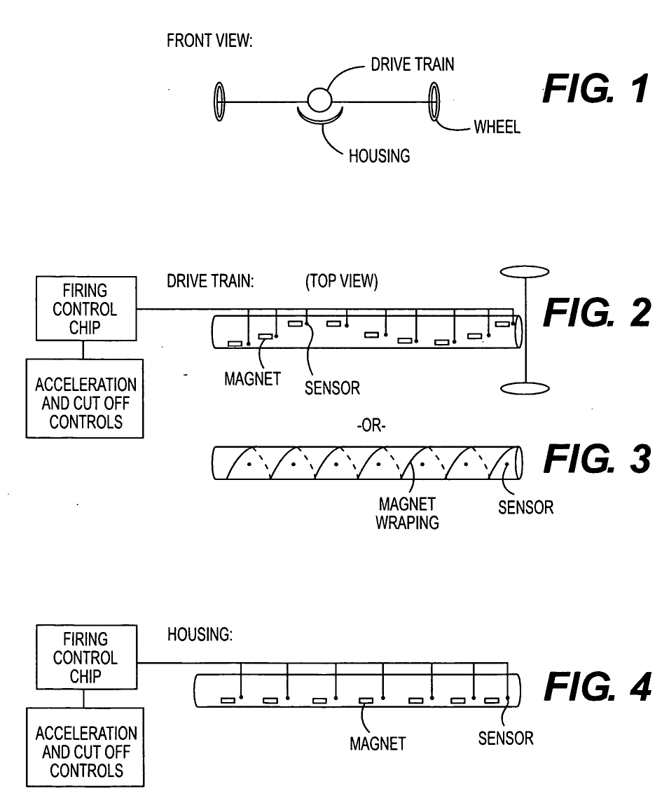

FIG. 1 shows a front view of a hybrid automobile propulsion system of the present invention. The drive train is maintained in its typical location. FIG. 2 shows a top view of a first magnet placement scheme. In this design, discrete magnets are placed at preferred locations along the drive shaft. The magnets are arranged spirally to ensure that there is always at least one magnet that is in position to be repelled by its corresponding magnet on the housing. FIG. 3 shows a top view of a second magnet placement scheme. In this design, the magnets are wrapped around the drive shaft in a spiral manner. In both designs, a sensor is associated with each magnet, and the sensors are operatively connected to a firing control system. The sensors can take any desired form. The firing control system also received input from other sources, such as the braking system or the driver. FIG. 4 shows a top view of a housing. The housing contains several magnets, each corresponding to and forming a magnet pair with magnets positioned on the drive train. In the embodiment illustrated in FIG. 4, the magnets are positioned linearly along the housing. Again, each of the housing magnets has a sensor associated therewith, and the sensors are operatively connected to the firing control system. As the drive shaft rotates, its magnets become aligned with housing magnets. When the sensors for a magnet pair detect that the magnets are in position to be repelled, they send a signal to the firing control system, which in turn temporarily provides electrical power to the magnets. The powered magnets create a magnetic repulsion, causing the drive train magnets to move away from the fixed housing magnets. This in turn causes the drive shaft to rotate, placing another pair of magnets in position for magnetic repulsion. The rotation of the drive shaft is transferred to the vehicle wheels in known manner.

The magnetic drive motor can also be used to generate electrical power. As described above, not all of the magnets will be in position for magnetic repulsion to rotate the drive shaft/axle. Those magnet pairs that are not being powered for magnetic repulsion can be used to generate electrical energy. To this end, coils of wire may be positioned surrounding the drive train and aligned with the magnets located there, generating electrical power in known fashion. Alternatively, additional magnets may be included on the drive shaft/axle to be used solely for purposes of generating electrical power.

This generated electrical energy can be stored in a capacitor, a battery, or another device so that the electricity can be used later by the magnetic drive motor to power or fire the other magnet pairs. It is possible that multiple magnet pairs will be used simultaneously to generate electricity while at the same time other multiple magnet pairs will be used to rotate the drive shaft/axle. The same firing control system can monitor all of the magnets and determine which magnet sets to use to generate electricity and which magnet sets to power for magnetic repulsion, as required.

This generating of electrical current through the magnetic drive motor will be combined with other sources, for example, the battery and the alternator, and used to repel the magnet sets when activated.

Generally, hybrid gasoline-electric vehicles are able to increase the overall fuel economy of the vehicle by supplementing the torque supplied by the internal combustion engine with an electric motor. Fuel efficiency improvements are generally achieved by storing energy from the engine during periods of lower demand on the engine. Several methods may be used to implement a hybrid electric drive.

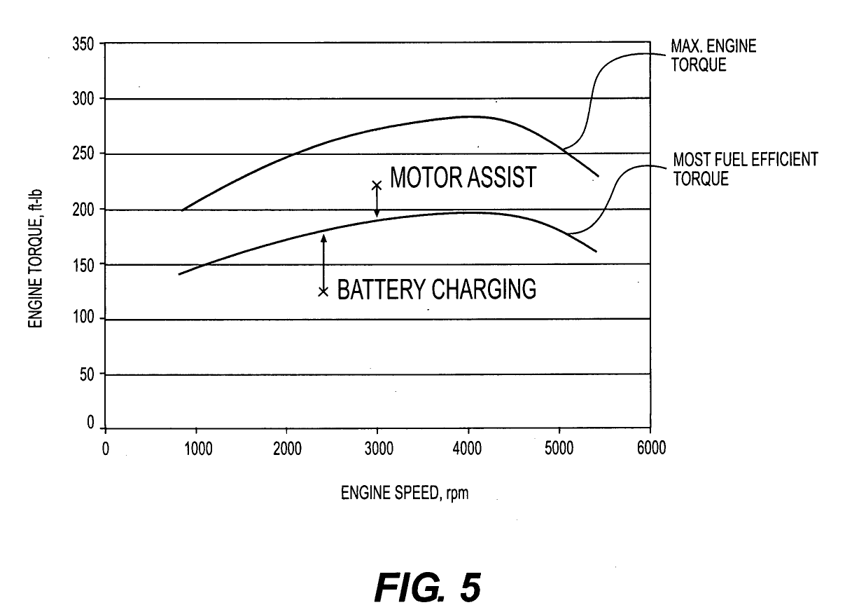

One such method is known as “motor assist.” Internal combustion engines are most efficient in the 1500 to 2500 rpm range at torque levels approximately 70% of peak. Outside of this range, fuel efficiency decreases due to internal losses such as friction or incomplete combustion. The vehicle's transmission determines the gear that provides the road load at the most efficient combination of engine speed and torque. However, with only four or five gears available, the engine is operated at many inefficient combinations. Fuel efficiency improvements are possible by using an electric hybrid drive in which the electric motor assists the engine when the road load demands engine torques that are higher than the most fuel efficient and by charging the batteries when the road load demands engine torques that are lower than the most fuel efficient. This concept is illustrated in FIG. 5.

Inclusion of an electric motor allows the internal combustion engine to be down-sized. This method is an extension of the previously described motor assist concept. The addition of the electric motor allows the vehicle designer to size the internal combustion engine for average driving requirements without sacrificing vehicle performance. In addition to reducing the weight of the vehicle, the smaller engine will, on average, operate at more efficient loads. This method is primarily for use for new vehicle design.

A significant amount of fuel is expended when the vehicle is stopped and the engine is idling. Many hybrid vehicles will shut off the engine when idling and quickly re-start the engine when required. The fuel savings achieved are significant during city (stop and go) driving. To implement idle-off, the electric motor plays a dual role as the engine starter motor. Due to the increased power of the electric motor compared to a typical starter motor, combustion engine start-up time is greatly reduced. However, belt driven auxiliaries, such as air conditioner compressors, will also shutdown during idle periods. Thus, to maintain passenger comfort, these auxiliaries should be replaced with electrically powered versions.

The electric motor may also serve as a generator. During periods of braking and coasting, the generator is turned on. This effectively results in increased engine braking as some of the inertial power of the vehicle is converted to electricity. This recovered energy (about 10% of the total energy lost to braking) can then be stored and used to power the motor at a later time, increasing the overall fuel economy. The placement of the motor/generator after the transmission in the inventive system means that the energy conversion from the generator would not incur additional losses from the transmission. In comparison, recharging the batteries from an upgraded DC alternator placed before the transmission would not incur these losses. Because the energy recovered from braking is a small fraction of the energy converted during cruising, the use of a DC alternator is preferred more than a motor/generator.

By decoupling the combustion engine from the drive train, propulsion power can be supplied by only the electric motor. This mode of operation can increase fuel economy by generating and storing electrical power during periods of high engine efficiency and low fuel consumption. The engine is then decoupled from the drive train during periods of low engine efficiency and high fuel consumption.

It is contemplated that the inventive system will operate in either a motor assist mode or a switched engine-motor mode. Because higher and more frequent peak torques are expected during city driving, the motor assist mode is preferred during city driving. The switched engine-motor operation is more effective during highway driving, where consistent “base” loads on the engine are expected.

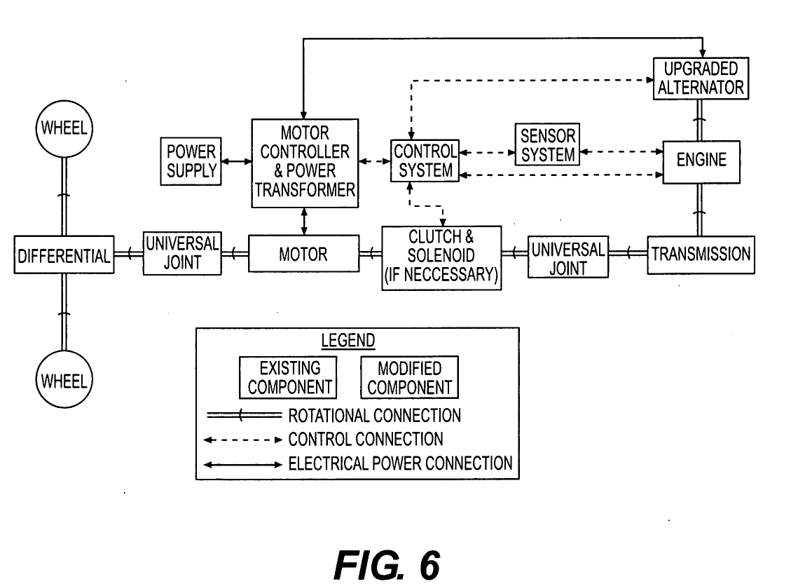

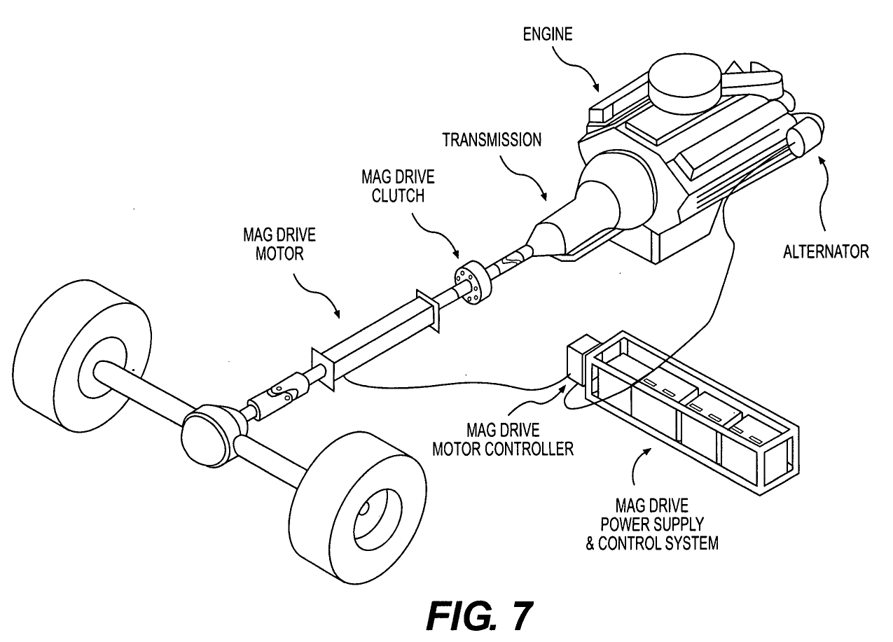

FIG. 6 shows a schematic diagram for an automobile engine and drive train of the present invention, and FIG. 7 shows a graphic representation of an automobile engine and drive train of the present invention. As seen in the figures, the motor's rotor corresponds to the vehicle drive shaft. This may be accomplished in a variety of manners. For instance, the drive shaft and the rotor may physically by the same part. Alternatively, the drive shaft and motor may be couple together by welding, fusing, or another joining means. It may be desirable to have a clutch mechanism incorporated into the drive shaft-rotor connection to allow the drive shaft to rotate independently of the motor. Placing the motor on the drive shaft side of the transmission, as opposed to between the internal combustion engine and the transmission, beneficially allows the inventive system to be incorporated into existing vehicles. Such retrofitting is not practically feasible with other hybrid systems due to the high level of modification and other work required to incorporate those systems.

The electric motor is the main component of the inventive system, with the motor's rotor corresponding to the vehicle's drive shaft. In addition to the magnetic drive motor discussed above, additional possible motor types that can be used with the inventive system include Permanent Magnet Brushless DC Motors, AC Induction Motors, and Switched/Variable Reluctance Motors. The advantages and disadvantages of these motor types are listed in Table 1 below. AC induction motors are preferred due to their wide availability, high reliability, and low cost. Permanent magnet brushless motors are also preferred because they are typically lighter in weight and less sensitive to changes in the air gap than AC induction motors.

TABLE 1

| Motor Type | Advantages | Disadvantages |
|---|---|---|
| Permanent Magnet | High torque per mass | Higher cost |
| Brushless DC | Motors and drives reasonably | Magnets can demagnetize due |
| | available | to shock or extreme |
| | | temperatures |
| AC Induction | Low cost | Additional cooling required |
| | Motors and drives widely | Sensitivity to air gap (i.e., rotor |
| | available | vibration) |
| | Quiet | Rotor coil resistive losses in |
| | Medium torque per mass | generating mode |
| | Very reliable | |
| Variable/Switched | Rotor is inert and therefore | Requires precise rotor position |
| Reluctance | easy to manufacture and robust | detection |
| | Lowest cost | Requires close air gap |
| | | tolerances |
| | | Generates audible noise |

Recharging from the alternator reduces additional mechanical conversion losses which would be incurred by a motor/generator (downstream of the transmission) setup. Recharging from the alternator also allows the inventive system to recharge the batteries during engine idle, improving the engine efficiency during these periods. Vehicle alternators have extremely low power generation ratings compared to the inventive motor ratings, ranging from approximately 0.1 HP to 1 HP for passenger vehicles and heavy duty trucks, respectively. This will increase the required charging time relative to the electric motor cruising time. For example, a battery pack sized to provide cruising power to a 30 HP motor for 20 minutes would require approximately 20 hours to be recharged by a 0.5 HP alternator. In order to reduce recharge time, the existing vehicle alternator should be upgraded to a rating more appropriate to the motor size.

The motor of the inventive system requires a power supply for energy storage. Preferred energy storage media and their major characteristics include:
Nickel Metal Hydride (NiMH)—lowest price-to-energy storage ratio, current standard for hybrid vehicle energy storage
Lithium Ion—medium price-to-energy storage ratio, higher lifetime than NiMH
Ultracapacitors—essentially infinite lifetime, highest cost NiMH battery cells are preferred because of their low cost relative to the other options. Ultracapacitors are also preferred due to their high reliability and ability to handle large amounts of charge/discharge cycles. Ultracapacitors, however, are still highly developmental and suffer from an extremely high price-to-energy storage ratio and low operating voltages.

The inventive system includes a motor controller/variable speed drive capable of controlling motor torque output independent of motor (i.e., vehicle) speed. The motor controller will be responsible for the following functions:
receiving control input from the control system
converting the DC power supply into the required power output for the motor
transforming the 12V DC current from the vehicle alternator into the required voltage for recharging the power supply

The inventive system includes a control system for determining the ideal operating state (charging/idle/discharging) according to operation logic and for providing input to the motor controller. This includes controlling the motor torque output, and communicating with the vehicle engine control unit (ECU) to determine driver throttle control (i.e., gas pedal), brake pedal position, vehicle speed, and current transmission gear to determine the required motor torque output. The motor speed and rotor position are monitored in order to provide accurate torque control independent of speed. The inventive system will either communicate with the vehicle ECU to control an existing vehicle clutch to disengage the engine when required, or include controls for an additional clutch. The vehicle alternator will be controlled by the inventive system to recharge the power supply during optimal time periods. The control system determines the battery state of charge and controls the alternator accordingly.

A clutch is provided between the motor and the transmission to switch to an electric-propulsion only mode. Preferably, a hydraulic clutch powered by the existing transmission hydraulic system and actuated by a solenoid controlled by the inventive control system is used.

The inventive system may also include other less significant components. For example, universal joints may be provided to isolate the motor from engine and axle vibration, particularly from the vehicle suspension. Vibration dampers for the motor may be provided. A framework to mount the motor and power supply to the vehicle chassis may be included. Due to the additional motor and power supply weight on the vehicle chassis, a reinforcing structure may be included. Additionally, electrical power and control system wiring and harnesses will likely be included.

The benefits of using the inventive system were estimated based on varying factors. Regarding fuel, savings due to reduced fuel consumption were estimated for use of the inventive system under typical vehicle operating conditions. Fuel savings were estimated based on performance of existing hybrid vehicles and EPA Fuel Economy ratings. Estimated fuel savings are presented in Table 2.

TABLE 2

| | Gasoline (Lincoln Town | Diesel | Diesel |
|---|---|---|---|
| | Car, Taxi, Postal Cab) | (Step Van) | (Class 8) |
| City Fuel Savings | 6% | 4% | 5% |
| Highway Fuel Savings | 14% | 9% | 2% |

It is important to note that these results do not contemplate inclusion of a down-sized engine, and the results reflect the engine running at all times. Additional savings can be realized if the idle-off design is implemented into the system. This improvement to fuel savings would apply mostly during city driving. Table 3 below summarizes fuel savings estimates for idle-off operation.

TABLE 3

| | Gasoline (Lincoln Town | Diesel | Diesel |
|---|---|---|---|
| | Car, Taxi, Postal Cab) | (Step Van) | (Class 8) |
| City Fuel Savings | 25% | 15% | 20% |
| Highway Fuel Savings | 17% | 10% | 3% |

These estimates were based on fuel costs of $2.357 per gallon for gasoline and $2.489 per gallon for diesel.

The use of the terms “a” and “an” and “the” and similar references in the context of describing the invention are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein.

As used herein, any directional references such as rear, front, lower, etc. are included to facilitate comprehension of the inventive concepts disclosed herein, and should not be read or interpreted as limiting.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments, but should be defined only in accordance with the following claims and their equivalents. Furthermore, while certain advantages of the invention have been described herein, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

What is claimed is:

1. A vehicle propulsion system, comprising:
an internal combustion engine;
a transmission operationally coupled to said engine;
a drive shaft operationally coupled to said transmission and at least one wheel; and
a electric motor coupled to said drive shaft intermediate said transmission and said wheel.

2. The system of claim 1, wherein said motor is selected from the group consisting of permanent magnet brushless dc motors, ac induction motors, switched/variable reluctance motors, and magnetic drive engine motors.

3. The system of claim 1, further comprising:
a controller operatively connected to said engine, said transmission, and said motor;
wherein said controller includes a memory containing logic to control said engine, said transmission, and said motor.

4. The system of claim 3, wherein said controller receives input regarding load requirements and controls said motor and engine based upon said input.

5. The system of claim 4, wherein said input is received from at least one of said engine, said transmission, and said motor.

6. The system of claim 4, wherein said controller receives said input at least in part from said transmission.

7. The system of claim 3, further comprising:
a electrical charge storage device operatively connected to said motor and said controller; and
an alternator operatively connected to said electrical charge storage device and said controller;
wherein said controller memory contains logic such that said controller will cause said alternator to recharge said electrical charge storage device when predetermined conditions are satisfied.

8. The system of claim 7, wherein said predetermined conditions include a storage level of said electrical charge storage device falling below a threshold level and said electrical charge storage device being in an operational state to receive electrical charge from said alternator.

9. The system of claim 3, wherein said controller memory contains logic to control which of said engine and said motor impart rotational force to said drive shaft.

10. A propulsion system for an automobile, comprising:
a drive shaft;
a first set of magnets positioned along said drive shaft;
a first set of sensors corresponding to the first set of magnets;
a second set of magnets; and
a second set of sensors corresponding to the second set of magnets.

11. The system of claim 10, wherein said first set of magnets are positioned in a spiral array along said drive shaft.

12. The system of claim 10, further comprising:
a source of electrical energy; and
a control system operatively connected to said first and second sets of sensors, said source of electrical energy, and at least one of said first and second sets of magnets to selectively charge individual magnets within said at least one of said first and second sets of magnets and thereby impart a rotational force to said drive shaft via magnetic repulsion.

13. The system of claim 10, further comprising a plurality of wire coils positioned surrounding said drive shaft and aligned with said first set of magnets for generating electrical power.

14. The system of claim 10, further comprising a third set of magnets positioned along said drive shaft and a plurality of wire coils positioned surrounding said drive shaft and aligned with said third set of magnets for generating electrical power.

15. The system of claim 10, wherein said second set of magnets is positioned on a non-rotating portion of the automobile.

16. A method of propelling an automobile, comprising:
providing a drive shaft;
providing a plurality of magnet sets along said drive shaft;
providing a set of sensors corresponding to each of said magnet sets;
providing a source of electrical energy connected to said magnets sets via said sensors sets; and
alternately powering sets of said plurality of magnet sets via said source of electrical energy to rotate said drive shaft via magnetic repulsion.

17. The method of claim 16, further comprising selectively engaging and disengaging an internal combustion engine.

18. The method of claim 16, further comprising:
providing a plurality of wire coils positioned around said drive shaft and aligned with at least one of said plurality of magnet sets; and
charging said source of electrical energy via said at least one set and said coils.
